(19) United States
(12) Patent Application Publication
(10) Pub. No.: US 2026/0072189 A1
(43) Pub. Date: Mar. 12, 2026

(54) PASSIVE SOURCE SEISMIC RE-DATUMING/POSITIONING AND DECONVOLUTION FOR SUB-SURFACE IMAGING

(71) Applicant: Schlumberger Technology Corporation, Sugar Land, TX (US)

(72) Inventors: Krishna Ramani, Crawley (GB); Daniele Boiero, Houston, TX (US)

(21) Appl. No.: 19/294,771

(22) Filed: Aug. 8, 2025

Related U.S. Application Data
(60) Provisional application No. 63/691,421, filed on Sep. 6, 2024.

(51) Int. Cl. G01V 1/30; E21B 49/00

(52) U.S. Cl. CPC G01V 1/30; E21B 49/00; G01V 2210/675

(57) ABSTRACT

Systems and methods for determining Green's function between known receiver positions based upon seismic data from an unknown source, the unknown source having unknown source positions and unknown source characteristics. The systems and methods include estimating an up-going component and a down-going component of the seismic data at receivers of the seismic data by combining particle motion characteristics of the seismic data, assigning geometry to the unknown source by computing a point spread function (PSF) based on a conjugate transpose of the down-going component at the receivers and the down-going component at the receivers, and computing a cross-correlation function (CF) based on the conjugate transpose of the down-going component and the up-going component at the receivers, interpolating the PSF and the CF across the receivers, estimating a Green's function based on the interpolated CF and the interpolated PSF, and taking an action based on the Green's function.

### CROSS-REFERENCE TO RELATED APPLICATIONS

This application claims priority to U.S. Provisional Patent Application No. 63/691,421, filed on Sep. 6, 2024, which is incorporated by reference.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Currently, seismic sources like air guns or controlled explosions are used to generate seismic waves for subsurface exploration. Other types of noise, such as, for example, but not limited to, ambient noise, may produce acoustic energy. Acoustic energy can penetrate the water column and interact with the seabed, producing seismic waves. Ambient noise may be considered unwanted noise in seismic data acquisition, as it can interfere with the signals from traditional seismic sources. What is needed is a way to use ambient noise constructively, for example, using cross-correlation techniques to image subsurface structures. Such a system may reduce the need for additional seismic sources, and may reduce the environmental footprint compared to traditional seismic sources like air guns, which can be disruptive to marine life.

### SUMMARY

Ambient noise such as, for example, but not limited to, propeller noise, can be acquired as a continuous wavefield and can be turned into a signal by (1) estimating the emitted source by isolating the energy coming from the ambient noise, and (2) deconvolving the source from the recorded signal to obtain the Earth response.

In some configurations, a method in accordance with embodiments of the present disclosure may be based on multidimensional deconvolution (MDD) where data are separated into an up/down propagating wavefield by using multicomponent measurements (for example, but not limited to, pressure and particle velocity) or where these measurements are used directly in the MDD process. The emitted source does not have to be estimated, and the receiver sampling to perform multidimensional convolution is obtained by interpolating the products of MDD, correlation functions and point spread functions. The point spread function is a representation of the distortion of the signal by the detector. These products show characteristics that look more like traditionally acquired seismic data compared to the propeller noise and can be interpolated using interpolation tools such as, for example, but not limited to, tools that use moveout corrections for de-aliasing. Interface post critical noise such as, for example, but not limited to, Scholte waves, that does not satisfy MDD assumptions, is removed by combining different components, for example, but not limited to, pressure and vector particle velocity components, pre- or post-correlation/point spread function computation in a sparse domain representation.

Systems and methods in accordance with embodiments of the present disclosure are agnostic to source characteristics. Energy is used to image the subsurface. If the characteristics of the sources are not known, if there is enough energy in the subsurface, and sensors to receive the energy, the source type and location information are not needed. In some cases, subsurface properties may be tracked, but what is deployed to accomplish the tracking may not be important. For example, seismic data collections could have occurred two years apart. If the use is to make sure stored carbon isn't leaking, subsurface characteristic determination is begun by frequency monitoring to minimize the cost of stored carbon monitoring.

If there are enough sources, the layer of fluid and spurious information between the sources and the receivers in a seismic data collection area serves to cancel the need for knowing the characteristics of the sources. The information between the receivers provides the subsurface properties. If two observations are similar, anything not similar may be deemed spurious. Characteristics of the source and layer between the sources and receivers may be deemed similar. The receivers may be ocean bottom nodes (OBNs), and may include pressure sensors and vibration detectors that indicate directionality of the signal—up, down, or sideways, for example.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer program product for determining Green's function between known receiver positions and from seismic data from an unknown source. The computer program product includes a computer readable storage medium having program instructions embodied therewith. The program instructions are executable by a computing device to cause the computing device to perform operations. The operations include estimating an up-going component and a down-going component of the seismic data at receivers of the seismic data by combining particle motion characteristics of the seismic data. The operations also include assigning geometry to the unknown source by computing a point spread function (PSF) based on a conjugate transpose of the down-going component at the receivers and the down-going component at the receivers, and computing a cross-correlation function (CF) based on the conjugate transpose of the down-going component and the up-going component at the receivers. The operations also include interpolating the PSF and the CF across the receivers. The operations also include estimating the Green's function based on the interpolated CF and the interpolated PSF. The operations also include taking an action based on the Green's function. The action may include redatuming the Green's function at a desired sea level, and/or inferring properties of subsoil for exploration purposes based at least on the estimated Green's function. The operations optionally include removing post-critical seismic data from the seismic data. The operations may also optionally include obtaining an estimate of the Green's function by minimizing a misfit between the up-going component and the down-going component. The unknown source may include one or more of an active source, a passive source, a marine vessel, or a land-based vessel. The estimated Green's function may include an assumption that a layer above the receivers is a homogeneous medium that does not affect propagation below the receivers. The PSF may include an amount that the seismic data is blurred. Interpolating may include using moveout corrections or prior information for de-aliasing, and the particle motion characteristics may include one or more of pressure, particle velocity, or particle acceleration. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, in accordance with embodiments of the present disclosure.

FIGS. 2-5 illustrate schematic views of an oilfield having subterranean formation containing reservoir therein in accordance with embodiments of the present disclosure.

FIG. 6 illustrates a schematic view, partially in cross section, of an oilfield having data acquisition tools in accordance with embodiments of the present disclosure.

FIG. 7 illustrates an oilfield for performing production operations in accordance with embodiments of the present disclosure.

FIG. 8 illustrates a schematic view of a computing system for performing at least a portion of the method(s) herein, according to an embodiment.

FIG. 9 is a pictorial representation of wavefront decomposition.

FIG. 10 is a pictorial representation of a redatumed wavefield described by Green's function.

FIG. 11 is a flowchart of a method in accordance with embodiments of the present disclosure.

FIG. 12 is a flowchart of a method in accordance with further embodiments of the present disclosure.

It should be noted that some details of the figures have been simplified and are drawn to facilitate understanding rather than to maintain strict structural accuracy, detail, and scale.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining”or “in response to detecting,”depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

Attention is now directed to processing procedures, methods, techniques, and workflows that are in accordance with some embodiments. Some operations in the processing procedures, methods, techniques, and workflows disclosed herein may be combined and/or the order of some operations may be changed.

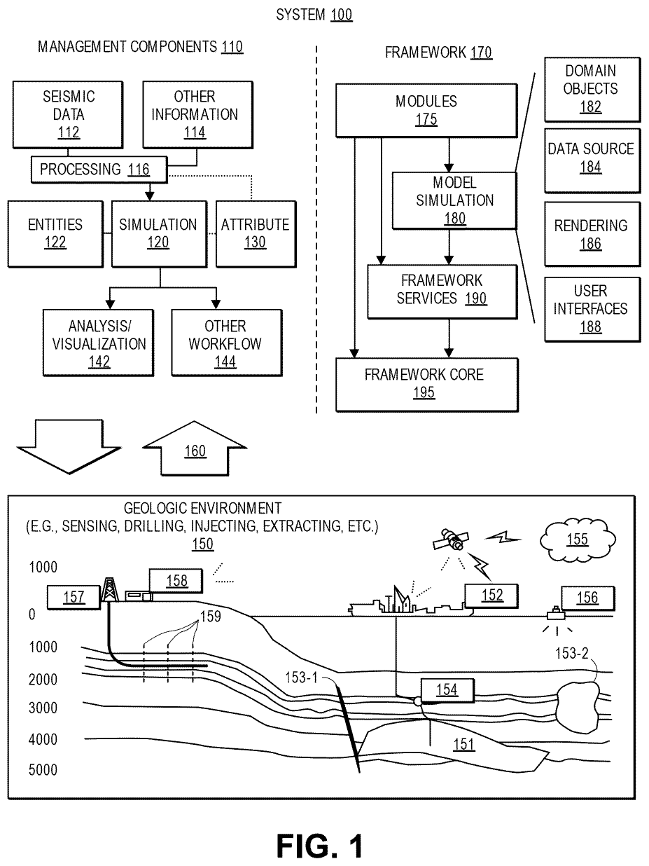

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® . NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a reservoir simulator. As an example, a simulation component, a simulator, etc. may include features to implement one or more meshless techniques (e.g., to solve one or more equations, etc.). As an example, a reservoir or reservoirs may be simulated with respect to one or more enhanced recovery techniques.

In an example embodiment, the management components 110 may include features such as components that allow for optimization of exploration and development operations. Seismic to simulation software components may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may include one or more worksteps that access a module such as a plug-in (e.g., external executable code, etc.).

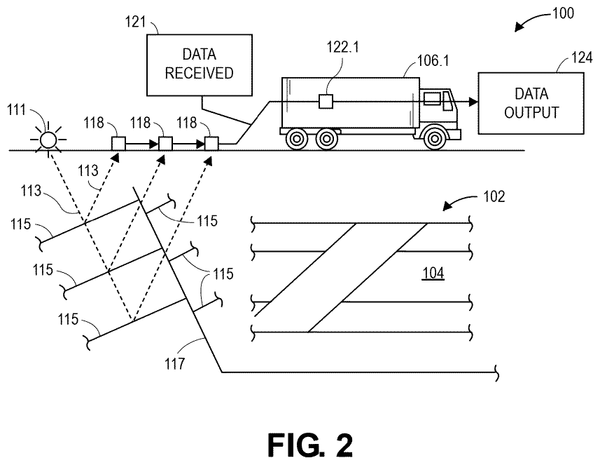

The field configurations of FIGS. 2-5 are intended to provide a brief description of an example of a field usable with oilfield application frameworks. Part of, or the entirety, of the oilfield may be on land, water, and/or sea. Also, while a single field measured at a single location is depicted, oilfield applications may be utilized with any combination of one or more oilfields, one or more processing facilities and one or more wellsites.

FIG. 2 illustrates a survey operation being performed by a survey tool, such as seismic truck 106.1, to measure properties of the subterranean formation. The survey operation is a seismic survey operation for producing sound vibrations. In FIG. 2, one such sound vibration, e.g., sound vibration 113 generated by source 111, reflects off horizons 115 in earth formation 117. A set of sound vibrations is received by sensors, such as geophone-receivers 118, situated on the earth's surface. The data received 121 are provided as input data to a computer 122.1 of a seismic truck 106.1, and responsive to the input data, computer 122.1 generates seismic data output 124. This seismic data output may be stored, transmitted or further processed as desired, for example, by data reduction.

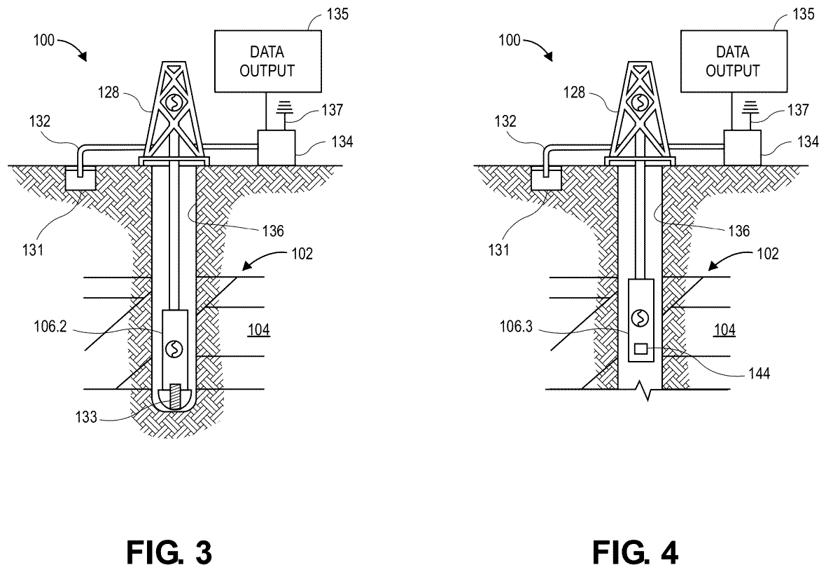

FIGS. 3-5 illustrate tools used to measure properties of an oilfield. It will be appreciated that the tools may be used in connection with non-oilfield operations, such as gas fields, mines, aquifers, storage or other subterranean facilities. Also, while some data acquisition tools are depicted, it will be appreciated that various measurement tools capable of sensing parameters, such as seismic two-way travel time, density, resistivity, production rate, etc., of the subterranean formation and/or its geological formations may be used. Various sensors may be located at various positions along the wellbore and/or the monitoring tools to collect and/or monitor the desired data. Other sources of data may also be provided from offsite locations.

FIG. 3 illustrates a drilling operation being performed by drilling tools 106.2 suspended by rig 128 and advanced into subterranean formations 102 to form wellbore 136. Mud pit 131 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield, for example at the surface unit 134, and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors may be collected by surface unit 134 and/or other data collection sources for analysis or other processing. The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield or other locations. Surface unit 134 may also be provided with or functionally connected to one or more controllers (not shown) for actuating mechanisms at the oilfield. Surface unit 134 may then send command signals to the oilfield in response to data received. Surface unit 134 may receive commands via transceiver 137 or may itself execute commands to the controller. A processor may be provided to analyze the data (locally or remotely), make the decisions and/or actuate the controller. In this manner, the oilfield may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 4 illustrates a wireline operation being performed by wireline tool 106.3 suspended by rig 128 and into wellbore 136. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source that sends and/or receives electrical signals to surrounding subterranean formations 102 and fluids therein.

Wireline tool 106.3 may be operatively connected to, for example, geophones 118 and a computer 122.1 of a seismic truck 106.1 (FIG. 2). Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about the oilfield to collect data relating to various field operations as described previously. As shown, a sensor is positioned in wireline tool 106.3 to measure downhole parameters which relate to, for example porosity, permeability, fluid composition and/or other parameters of the field operation.

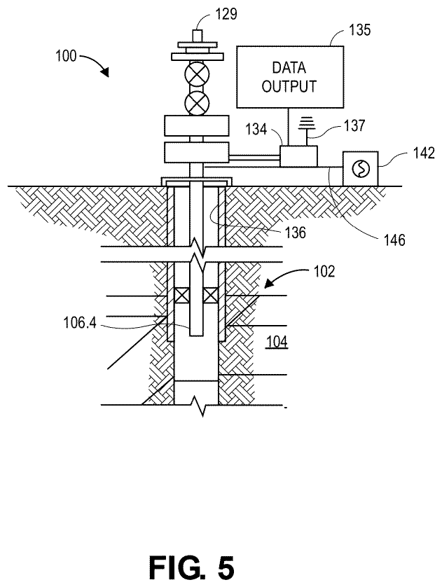

FIG. 5 illustrates a production operation being performed by production tool 106.4 deployed from a production unit or Christmas tree 129 and into completed wellbore 136 for drawing fluid from the downhole reservoirs into surface facilities. The fluid flows from reservoir 104 through perforations in the casing (not shown) and into production tool 106.4 in wellbore 136 and to surface facilities via gathering network 146.

Sensors, such as gauges, may be positioned about the oilfield to collect data relating to various field operations as described previously. As shown, the sensor may be positioned in production tool 106.4 or associated equipment, such as Christmas tree 129, gathering network 146, surface facility, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

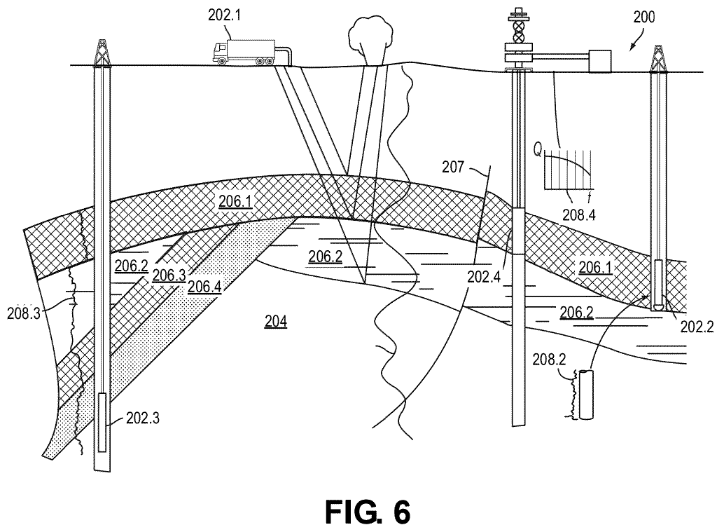

FIG. 6 illustrates a schematic view, partially in cross section, of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2-5, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4 As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

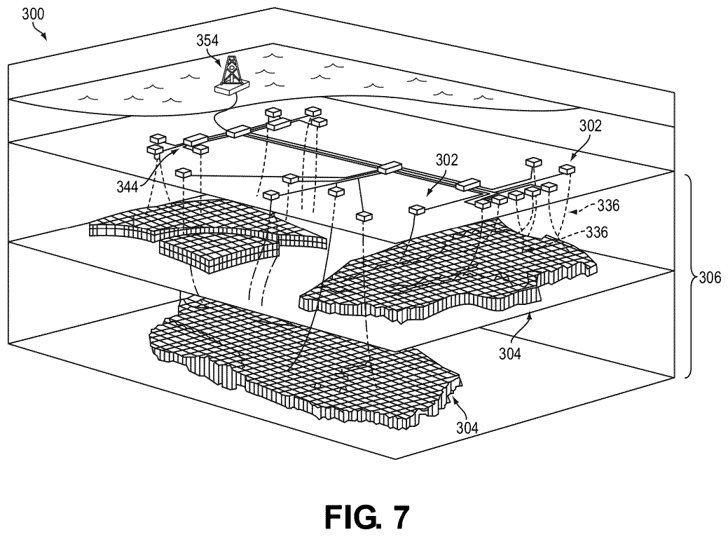

FIG. 7 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 7 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

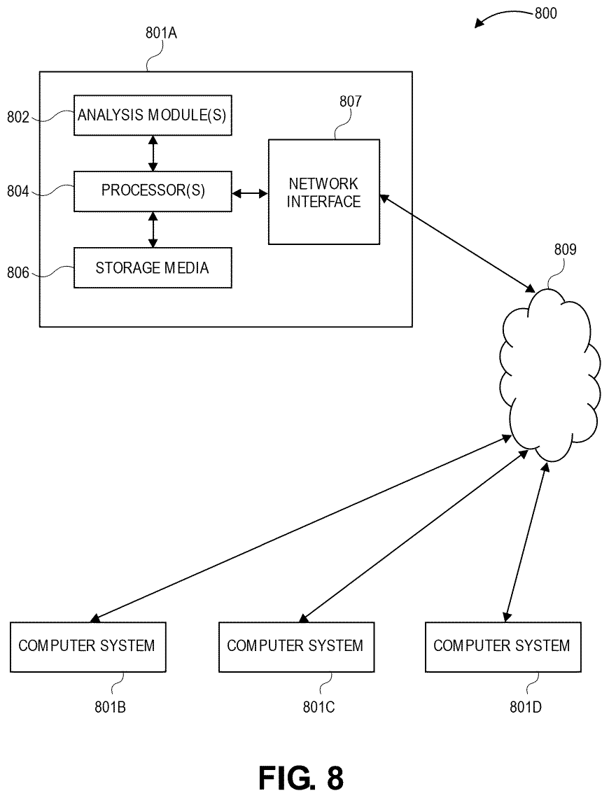

FIG. 8 illustrates a schematic view of a computing system for performing at least a portion of the method(s) herein, in accordance with embodiments of the present disclosure. In some configurations, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

Continuing to refer to FIG. 8, a processor may include a microprocessor, microcontroller, processor module or subsystem, programmable integrated circuit, programmable gate array, or another control or computing device.

Continuing to refer to FIG. 8, the storage media 806 may be implemented as one or more computer-readable or machine-readable storage media. Note that while in the example embodiment of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

Continuing to refer to FIG. 8, in some embodiments, computing system 800 contains one or more time-lapse seismic module(s). It should be appreciated that computing system 800 is merely one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

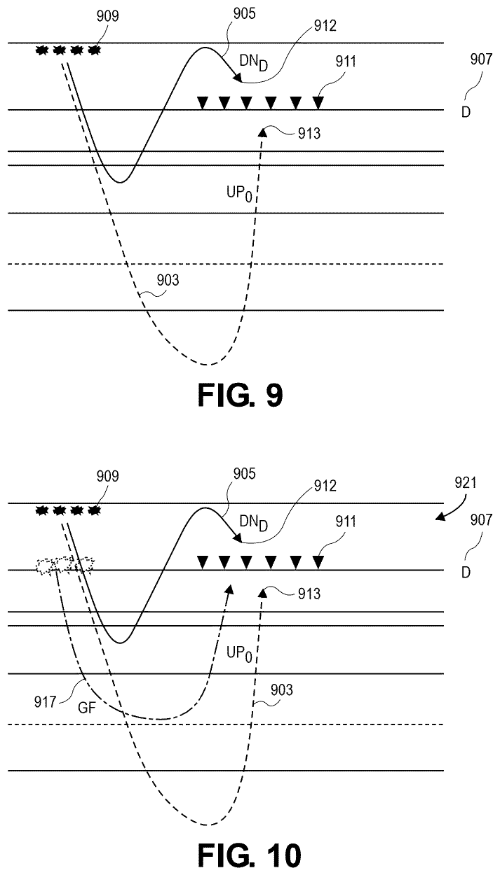

Referring now to FIG. 9, seismic data are generated by an unknown source, for example, the propeller of a boat in the 909 area, or a combination of known or unknown sources. In FIGS. 9 and 10, the stars 909 represent the unknown sources, and the triangles are receivers 911 along the datum D 907. Arrows 912/913 denote seismic data decomposition in terms of components that are either down-going DN 912 or up-going UP 913. Estimating the Green's function (GF) 917 when source positions and characteristics are unknown is described herein.

The process of estimating the GF begins by combining particle motion characteristics of the seismic data. The seismic data may be separated into up-going components (UP D) 903 and down-going components (DN D) 905 received at datum D 907 as in the following integral equation over receivers xᵣ:

$${UP}_{D} ¿2 {\int }_{\partial D} DNDGF {dx}_{r} \qquad ( 1 )$$

The estimated GF in equation 1 corresponds to a dataset that is acquired with sources 909 and receivers 911 at datum D 907, and that conforms to the assumption that the layer 921 is a homogeneous medium that does not affect what propagates below datum D 907. For the inversion of equation 1, the integration along the receivers is discretized to a summation, and the equation is written in matrix form for the angular frequencies separately:

$${UP}_{D} ¿ DNDGF \qquad ( 2 )$$

A point spread function (PSF) Γ_{GF}, indicating the amount the signal is blurred or distorted, and the matrix of the cross-correlation function (CF) C_{GF} between the up-going components and the down-going components may be computed as Γ_{GF}=(DN_{D})^{H}DN_{D} and C_{GF}=(DN_{D})^{H}UP_{D} respectively, where H denotes the conjugate transpose matrix. The objective is to obtain a least-squares estimate of the unknown GF by minimizing the misfit:

$${J}_{GF} = {‖ {UP}_{D} - {DN}_{D} GF ‖}_{2} \qquad ( 3 )$$

where ∥∥₂ denotes the l2-norm. The solution of Equation (3) can be written as:

$${C}_{GF} = {Γ}_{GF} {GF}^{⇔} GF = {( {Γ}_{GF} )}^{- 1} {C}_{GF} , \qquad ( 4 )$$

The GF may be obtained by convolving the inverse of the PSF with the CF. This convolution process relies on the PSF and the CF to be well sampled, and this may be satisfied by interpolation by, for example, but not limited to, tools that use moveout corrections or prior information for de-aliasing. Thus, through use of a system and method in accordance with embodiments of the present disclosure, the PSF and CF show characteristics that look like traditionally acquired seismic data rather than data gathered from unknown sources. Equation (4) states that the cross-correlation function C_{GF} is proportional to the sought Green's function GF, smeared in space and time by Γ_{GF}.

Referring now to FIG. 10, shown is a redatumed Green's function. The redatuming may improve the resolution of the gathered seismic data by removing blurring effects at datum D 907.

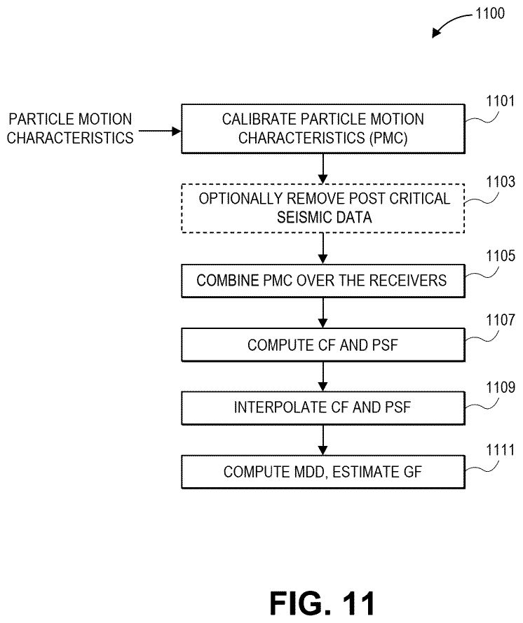

Referring now to FIG. 11, a method 1100 for determining Green's function between known receiver positions and from seismic data from an unknown source, the unknown source having unknown source positions and unknown source characteristics, is shown. The method 1100 may include calibrating 1101 particle motion characteristics such as, for example, but not limited to, pressure and vector particle velocity components pre-or post-correlation/point spread function computation in a relatively sparse domain representation. The method 1100 may include combining 1105 particle motion characteristics across the receivers at datum D 907 (FIGS. 9 and 10). The method 1100 may include computing 1107 a cross-correlation function and a point spread function based on the combined measurements, and interpolating 1109 the cross-correlation function and the point spread function between the receivers. The method 1100 may include computing 1111 multidimensional deconvolution, and estimating the GF. The method 1100 can optionally include removing 1103 post-critical seismic data from the calibrated particle motion characteristics. The method 1100 may be used to remove interface post-critical noise that does not satisfy MDD assumptions from the signals. Interface post-critical noise refers to signals that do not satisfy MDD assumptions such as, for example, but not limited to, an accurate detector response model, linearity of the measurements being deconvolved, constant signal distortion, a known medium and source, sufficient sampling, known noise characteristics, and subsurface layers that are horizontal. An example of post-critical noise in water is Scholte waves.

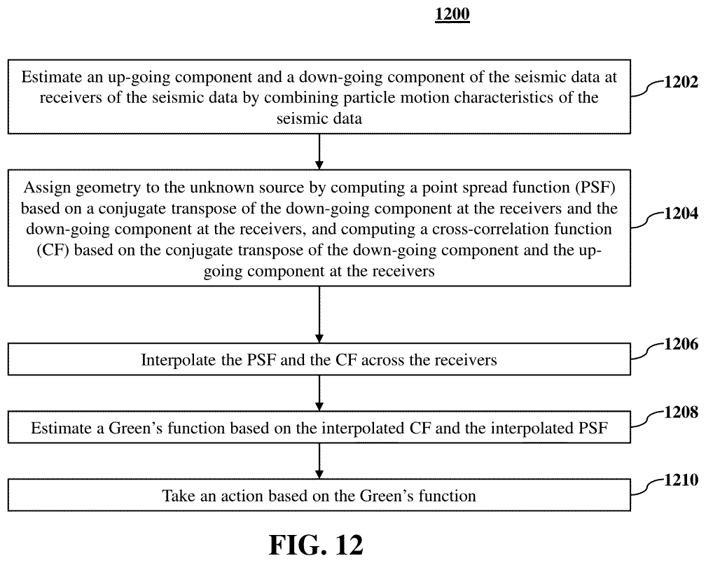

FIG. 12 is a flowchart of a method for determining Green's function between known receiver positions based upon seismic data from an unknown source, in accordance with embodiments of the present disclosure. The unknown source has unknown source positions and unknown source characteristics. Method 1200 may include block 1202 for estimating an up-going component and a down-going component of the seismic data at receivers of the seismic data by combining particle motion characteristics of the seismic data.

Method 1200 may include block 1204 for assigning geometry to the unknown source by computing a point spread function (PSF) based on a conjugate transpose of the down-going component at the receivers and the down-going component at the receivers, and computing a cross-correlation function (CF) based on the conjugate transpose of the down-going component and the up-going component at the receivers.

Method 1200 may include block 1206 for interpolating the PSF and the CF across the receivers.

Method 1200 may include block 1208 for estimating a Green's function based on the interpolated CF and the interpolated PSF.

Method 1200 may include block 1210 for taking an action based on the Green's function. The action may include inferring properties of subsoil for exploration purposes based at least on the estimated Green's function. The action may also or instead include redatuming the Green's function at a desired sea level. The action may also or instead be or include generating and/or transmitting a signal (e.g., using a computing system) that recommends, instructs, or causes a physical action to occur at a wellsite. The action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

What is claimed is:

1. A method for determining Green's function between known receiver positions based upon seismic data from an unknown source, the method comprising:
estimating an up-going component and a down-going component of the seismic data at receivers of the seismic data by combining particle motion characteristics of the seismic data;
computing a point spread function (PSF) based on a conjugate transpose of the down-going component at the receivers and the down-going component at the receivers;
computing a cross-correlation function (CF) based on the conjugate transpose of the down-going component and the up-going component at the receivers; and
estimating the Green's function based on the CF and the PSF.

2. The method of claim 1, further comprising:
taking an action based on the Green's function,
wherein the action includes redatuming the Green's function at a desired sea level.

3. The method of claim 2, wherein the action comprises:
inferring properties of subsoil for exploration purposes based at least on the estimated Green's function.

4. The method of claim 1, wherein the unknown source has unknown source positions and unknown source characteristics, and wherein the unknown source comprises:
one or more of an active source, a passive source, a marine vessel, or a land-based vessel.

5. The method of claim 1, further comprising:
removing post-critical seismic data from the seismic data;
assigning geometry to the unknown source; and
interpolating the PSF and the CF across the receivers.

6. The method of claim 1, further comprising:
obtaining an estimate of the Green's function by minimizing a misfit between the up-going component and the down-going component.

7. The method of claim 1, wherein the estimated Green's function comprises:
assuming that a layer above the receivers is a homogeneous medium that does not affect propagation below the receivers.

8. The method of claim 1, wherein the PSF comprises:
an amount that the seismic data is blurred.

9. The method of claim 1, wherein interpolating comprises:
using moveout corrections or prior information for de-aliasing.

10. The method of claim 1, wherein the particle motion characteristics comprise:
one or more of pressure, particle velocity, or particle acceleration.

11. A computer system for determining Green's function between known receiver positions based upon seismic data from an unknown source, the computer system comprising:
a hardware processor;
a non-volatile storage medium storing instructions that when executed by the hardware processor perform operations comprising:
estimating an up-going component and a down-going component of the seismic data at receivers of the seismic data by combining particle motion characteristics of the seismic data;
computing a point spread function (PSF) based on a conjugate transpose of the down-going component at the receivers and the down-going component at the receivers;
computing a cross-correlation function (CF) based on the conjugate transpose of the down-going component and the up-going component at the receivers; and
estimating the Green's function based on the CF and the PSF.

12. The computer system of claim 11, further comprising:
taking an action based on the Green's function,
wherein the action includes inferring properties of subsoil for exploration purposes based at least on the estimated Green's function.

13. The computer system of claim 11, wherein the unknown source has unknown source positions and unknown source characteristics, and wherein the unknown source comprises:
one or more of an active source, a passive source, a marine vessel, or a land-based vessel.

14. The computer system of claim 11, further comprising:
removing post-critical seismic data from the seismic data;
assigning geometry to the unknown source; and
interpolating the PSF and the CF across the receivers.

15. The computer system of claim 11, further comprising:
obtaining an estimate of the Green's function by minimizing a misfit between the up-going component and the down-going component.

16. The computer system of claim 11, wherein the estimated Green's function comprises:
assuming that a layer above the receivers is a homogeneous medium that does not affect propagation below the receivers.

17. The computer system of claim 11, wherein the PSF comprises:
an amount that the seismic data is blurred.

18. The computer system of claim 11, wherein interpolating comprises:
using moveout corrections or prior information for de-aliasing.

19. The computer system of claim 11, wherein the particle motion characteristics comprise:
one or more of pressure, particle velocity, or particle acceleration.

20. A computer program product for determining Green's function between known receiver positions based upon seismic data from an unknown source, the unknown source having unknown source positions and unknown source characteristics, the computer program product comprising a computer readable storage medium having program instructions embodied therewith, the program instructions executable by a computing device to cause the computing device to perform operations comprising:
estimating an up-going component and a down-going component of the seismic data at receivers of the seismic data by combining particle motion characteristics of the seismic data;
assigning geometry to the unknown source by computing a point spread function (PSF) based on a conjugate transpose of the down-going component at the receivers and the down-going component at the receivers, and computing a cross-correlation function (CF) based on the conjugate transpose of the down-going component and the up-going component at the receivers;
interpolating the PSF and the CF across the receivers;
estimating the Green's function based on the interpolated CF and the interpolated PSF;
taking an action based on the Green's function, the action including redatuming the Green's function at a desired sea level or inferring properties of subsoil for exploration purposes based at least on the estimated Green's function;
removing post-critical seismic data from the seismic data; and
obtaining an estimate of the Green's function by minimizing a misfit between the up-going component and the down-going component,
wherein
the unknown source comprises one or more of an active source, a passive source, a marine vessel, or a land-based vessel,
the estimated Green's function includes assuming that a layer above the receivers is a homogeneous medium that does not affect propagation below the receivers,
the PSF comprises an amount that the seismic data is blurred,
interpolating comprises using moveout corrections or prior information for de-aliasing, and
the particle motion characteristics include one or more of pressure, particle velocity, or particle acceleration.
